(19) United States
(12) Patent Application Publication
(10) Pub. No.: US 2026/0107336 A1
(43) Pub. Date: Apr. 16, 2026

(54) DIRECT-LINK ESTABLISHMENT METHOD, DEVICE AND STORAGE MEDIUM

(71) Applicant: Beijing Xiaomi Mobile Software Co., Ltd., Beijing (CN)

(72) Inventors: Zhengyi SHANG, Beijing (CN); Wei LU, Beijing (CN)

(73) Assignee: Beijing Xiaomi Mobile Software Co., Ltd., Beijing (CN)

(21) Appl. No.: 19/116,358

(22) PCT Filed: Sep. 29, 2022
(86) PCT No.: PCT/CN2022/122824

§ 371 Date: Mar. 27, 2025

(51) Int. Cl. H04W 76/14; H04W 12/03; H04W 12/041; H04W 88/04

(52) U.S. Cl. CPC H04W 76/14; H04W 12/03; H04W 12/041; H04W 88/04

(57) ABSTRACT

A method for establishing a direct link, including: transmitting a first message to third UE via second UE, where the first message is configured to request establishment of an end-to-end link, which is via the second UE, between the first UE and the third UE, and the second UE is a layer-2 relay UE; receiving a second message transmitted by the third UE via the second UE, where the second message is configured to request negotiation, of an end-to-end shared key shared by the first UE and the third UE, with the first UE; generating the end-to-end shared key by performing a security negotiation procedure with the third UE via the second UE; and receiving a third message transmitted by the third UE via the second UE, where the third message indicates completion of establishment of the end-to-end link.

### CROSS-REFERENCE TO RELATED APPLICATION

The present application is a U.S. National Stage of International Application No. PCT/CN2022/122824, filed on Sep. 29, 2022, the contents of which are incorporated herein by reference in their entirety for all purposes.

### BACKGROUND OF THE INVENTION

In a communication system, 5G proximity service (ProSe) can be introduced to better implement direct communication between user equipments (UEs).

In related art, the 5G ProSe can better solve the following problems. In a case where source UE cannot directly communicate with target UE, the source UE can attempt to communicate with a UE-to-UE relay first, and then communicate with the target UE through the UE-to-UE relay.

### SUMMARY OF THE INVENTION

The present disclosure relates to the field of communication technology, and particularly relates to a method for establishing a direct link, a device and a storage medium.

In a first aspect, an embodiment of the present disclosure provides a method for establishing a direct link. The method is performed by first user equipment (UE), and includes: transmitting a first message to third UE via second UE, where the first message is configured to request establishment of an end-to-end link, which is via the second UE, between the first UE and the third UE, and the second UE is layer-2 relay UE; receiving a second message transmitted by the third UE via the second UE, where the second message is configured to request negotiation, of an end-to-end shared key shared by the first UE and the third UE, with the first UE; generating the end-to-end shared key by performing a security negotiation procedure with the third UE via the second UE; and receiving a third message transmitted by the third UE via the second UE, where the third message indicates completion of establishment of the end-to-end link.

In a second aspect, an embodiment of the present disclosure provides a method for establishing a direct link. The method is performed by third user equipment (UE), and includes: receiving a first message transmitted by first UE via second UE, where the first message is configured to request establishment of an end-to-end link, which is via the second UE, between the first UE and the third UE, and the second UE is layer-2 relay UE; transmitting a second message to the first UE via the second UE, where the second message is configured to request negotiation, of an end-to-end shared key shared by the first UE and the third UE, with the first UE; generating the end-to-end shared key by performing a security negotiation procedure with the first UE via the second UE; and transmitting a third message to the first UE via the second UE, where the third message indicates completion of establishment of the end-to-end link.

In a third aspect, an embodiment of the present disclosure provides a method for establishing a direct link. The method is performed by second user equipment (UE), and includes: receiving a first message transmitted by first UE, where the first message is configured to request establishment of an end-to-end link, which is via the second UE, between the first UE and third UE, and the second UE is layer-2 relay UE; transmitting the first message to the third UE; receiving a second message transmitted by the third UE, where the second message is configured to request negotiation, of an end-to-end shared key shared by the first UE and the third UE, with the first UE; transmitting the second message to the first UE, so as to facilitate generating the end-to-end shared key by performing a security negotiation procedure by the first UE and the third UE; receiving a third message transmitted by the third UE, where the third message indicates completion of establishment of the end-to-end link; and transmitting the third message to the first UE.

In a fourth aspect, an embodiment of the present disclosure provides a device for establishing a direct link. The device is configured for first user equipment (UE). The device includes a transceiving module. The transceiving module is configured to: transmit a first message to third UE via second UE, where the first message is configured to request the establishment of an end-to-end link, which is via the second UE, between the first UE and the third UE, and the second UE is layer-2 relay UE; receive a second message transmitted by the third UE via the second UE, where the second message is configured to request negotiation, of an end-to-end shared key shared by the first UE and the third UE, with the first UE; generate the end-to-end shared key by performing a security negotiation procedure with the third UE via the second UE; and receive a third message transmitted by the third UE via the second UE, where the third message indicates completion of establishment of the end-to-end link.

In a fifth aspect, an embodiment of the present disclosure provides a device for establishing a direct link. The device is configured for third user equipment (UE). The device includes a transceiving module. The transceiving module is configured to: receive a first message transmitted by first UE via second UE, where the first message is configured to request the establishment of an end-to-end link, which is via the second UE, between the first UE and the third UE, and the second UE is layer-2 relay UE; transmit a second message to the first UE via the second UE, where the second message is configured to request negotiation, of an end-to-end shared key shared by the first UE and the third UE, with the first UE; generate the end-to-end shared key by performing a security negotiation procedure with the first UE via the second UE; and transmit a third message to the first UE via the second UE, where the third message indicates completion of establishment of the end-to-end link.

In a sixth aspect, an embodiment of the present disclosure provides a device for establishing a direct link. The device is configured for second user equipment (UE). The device includes a transceiving module. The transceiving module is configured to: receive a first message transmitted by first UE, where the first message is configured to request the establishment of an end-to-end link, which is via the second UE, between the first UE and third UE, and the second UE is layer-2 relay UE; transmit the first message to the third UE; receive a second message transmitted by the third UE, where the second message is configured to request negotiation, of an end-to-end shared key shared by the first UE and the third UE, with the first UE; transmit the second message to the first UE, so as to facilitate generating the end-to-end shared key by performing a security negotiation procedure by the first UE and the third UE; receive a third message transmitted by the third UE, where the third message indicates completion of establishment of the end-to-end link; and transmit the third message to the first UE.

In a seventh aspect, an embodiment of the present disclosure provides a communication device. The communication device includes one or more processors. The one or more processors invoke a computer program in a memory, so as to perform the method according to the first aspect.

In an eighth aspect, an embodiment of the present disclosure provides a communication device. The communication device includes one or more processors. The one or more processors invoke a computer program in a memory, so as to perform the method according to the second aspect.

In a ninth aspect, an embodiment of the present disclosure provides a communication device. The communication device includes one or more processors. The one or more processors invoke a computer program in a memory, so as to perform the method according to the third aspect.

In a tenth aspect, an embodiment of the present disclosure provides a communication device. The communication device includes one or more processors and a memory. The memory stores a computer program. The computer program stored in the memory, when being collectively executed by the one or more processors, causes the communication device to perform the method according to the first aspect.

In an eleventh aspect, an embodiment of the present disclosure provides a communication device. The communication device includes one or more processors and a memory. The memory stores a computer program. The computer program stored in the memory, when being collectively executed by the one or more processors, causes the communication device to perform the method according to the second aspect.

In a twelfth aspect, an embodiment of the present disclosure provides a communication device. The communication device includes one or more processors and a memory. The memory stores a computer program. The computer program stored in the memory, when being collectively executed by the one or more processors, causes the communication device to perform the method according to the third aspect.

In a thirteenth aspect, an embodiment of the present disclosure provides a communication device. The communication device includes one or more processors and an interface circuit. The interface circuit is configured to receive code instructions and transmit the code instructions to the one or more processors. The one or more processors are collectively configured to run the code instructions to cause the communication device to perform the method according to the first aspect.

In a fourteenth aspect, an embodiment of the present disclosure provides a communication device. The communication device includes one or more processors and an interface circuit. The interface circuit is configured to receive code instructions and transmit the code instructions to the one or more processors. The one or more processors are collectively configured to run the code instructions to cause the communication device to perform the method according to the second aspect.

In a fifteenth aspect, an embodiment of the present disclosure provides a communication device. The communication device includes one or more processors and an interface circuit. The interface circuit is configured to receive code instructions and transmit the code instructions to the one or more processors. The one or more processors are collectively configured to run the code instructions to cause the communication device to perform the method according to the third aspect.

In a sixteenth aspect, an embodiment of the present disclosure provides a communication system. The communication system includes the communication device according to the fourth, fifth, and sixth aspects. Alternatively, the communication system includes the communication device according to the seventh, eighth, and ninth aspects. Alternatively, the communication system includes the communication device according to the tenth, eleventh, and twelfth aspects. Alternatively, the communication system includes the communication device according to the thirteenth, fourteenth, and fifteenth aspects.

In a seventeenth aspect, an embodiment of the present disclosure provides a non-transitory computer-readable storage medium. The non-transitory computer-readable storage medium is configured to store instructions used by a terminal. The instructions, when being executed, cause the terminal to perform the method according to any one of the first aspect to the third aspect.

In an eighteenth aspect, the present disclosure further provides a computer program product including a computer program. The computer program, when running on a computer, causes the computer to perform the method according to any one of the first aspect to the third aspect.

In a nineteenth aspect, the present disclosure provides a chip system. The chip system includes at least one processor and an interface, and is configured to support a terminal to achieve functions involved in the method according to any one of the first aspect to the third aspect, and for instance, a function of determining or processing at least one of data and information involved in the method. In an example, the chip system further includes a memory. The memory is configured to store a computer program and data necessary for a source node and an auxiliary node. The chip system may be composed of chips, or may include a chip and other discrete devices.

In a twentieth aspect, the present disclosure provides a computer program. The computer program, when running on a computer, causes the computer to perform the method according to any one of the first aspect to the third aspect.

### BRIEF DESCRIPTION OF DRAWINGS

The above and/or additional aspects and advantages of the present disclosure will become obvious and comprehensible from the description of embodiments in conjunction with the drawings.

FIG. 1 is a schematic diagram of an architecture of a communication system according to an embodiment of the present disclosure.

FIG. 2 is a flowchart of a method for establishing a direct link according to an embodiment of the present disclosure.

FIG. 3 is a flowchart of another method for establishing a direct link according to an embodiment of the present disclosure.

FIG. 4 is a flowchart of yet another method for establishing a direct link according to an embodiment of the present disclosure.

FIG. 5 is a schematic diagram of a method for establishing a direct link according to the present disclosure.

FIG. 6 is a structural diagram of a device for establishing a direct link according to an embodiment of the present disclosure.

FIG. 7 is a structural diagram of another device for establishing a direct link according to an embodiment of the present disclosure.

FIG. 8 is a structural diagram of yet another device for establishing a direct link according to an embodiment of the present disclosure.

FIG. 9 is a block diagram of a communication device according to an embodiment of the present disclosure.

FIG. 10 is a block diagram of a chip according to an embodiment of the present disclosure.

### DETAILED DESCRIPTION OF THE INVENTION

Examples will be described in detail and illustratively shown in the accompanying drawings. When the following description involves the accompanying drawings, unless otherwise specified, an identical number in different accompanying drawings denotes identical or similar elements. Implementations described in the following examples do not denote all implementations consistent with embodiments of the present disclosure. On the contrary, the implementations are merely instances of a device and a method consistent with some aspects of the embodiments of the present disclosure as detailed in the appended claims.

The terms used in the embodiments of the present disclosure are merely to describe the specific embodiments, instead of limiting the embodiments of the present disclosure. The singular forms such as “a,” “an,” and “the” used in the embodiments of the present disclosure and the appended claims are also intended to include the plural forms, unless otherwise clearly stated in the context. It is to be further understood that the term “and/or” used in the disclosure refers to and includes any of one or more of the associated listed items or all possible combinations.

It is to be understood that although the terms first, second, and third may be used to describe various information in the embodiments of the present disclosure, the information is not to be limited to these terms. The terms are merely used to distinguish an identical type of information from each other. For instance, without departing from the scope of the embodiments of the present disclosure, first information may alternatively be referred to as second information, and similarly, second information may alternatively be referred to as first information. Depending on the context, the word “if” as used in the disclosure can be interpreted as “when” or “at the time of” or “in response to determining”.

In order to facilitate understanding, the terms involved in the disclosure will be firstly introduced.
1. 5G proximity service (ProSe)

ProSe refers to direct communication from a device to another device or between proximity mobile devices. Through a UE-to-UE relay, 5G ProSe can further expand the coverage of direct communication.
2. Internet key exchange vision2 (IKEv2)

IKEv2 is a mechanism of security key negotiation. IKEv2 allows securely performing identity authentication, key distribution and key negotiation on an insecure network, thus establishing an internet protocol security (IPSec) channel.
3. Proximity key management function (PKMF)

The PKMF includes generation, distribution, use, update and destruction of keys.

In related art, in a case where communication is conducted through layer-2 relay UE being an untrusted node, transmitted information might be compromised, leading to security (including integrity and confidentiality) of communication information between the UEs to be compromised. Further, this might result in a Man-in-the-Middle Attack (MITM) on a direct link with the source UE and with the target UE, leaking communication contents and compromising security of the 5G ProSe.

For better understanding of a method for establishing a direct link according to the embodiments of the present disclosure, a communication system applicable to the embodiments of the present disclosure will be firstly described below.

The embodiments of the present disclosure are described in detail below, and the embodiments are illustratively shown in accompanying drawings, throughout which identical or similar reference numerals denote identical or similar elements. The embodiments described with reference to the accompanying drawings are illustrative and only intended to explain the present disclosure, instead of limiting the present disclosure.

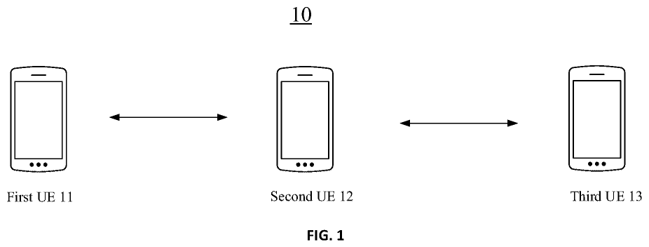

FIG. 1 is a schematic diagram of an architecture of a communication system according to an embodiment of the present disclosure. The communication system 10 may include, but is not limited to, one piece of first UE 11, one piece of second UE 12, and one piece of third UE 13. A number and a form of the devices shown in FIG. 1 are illustrative and do not limit the embodiments of the present disclosure. In practical application, the communication system 10 may include two or more pieces of first UE 11, two or more pieces of second UE 12, and two or more pieces of third UE 13. For instance, the communication system 10 shown in FIG. 1 includes one piece of first UE 11, one piece of second UE 12, and one piece of third UE 13.

It is to be noted that technical solutions of the embodiments of the present disclosure may be applied to various communication systems, such as a long term evolution (LTE) system, a 5th generation (5G) mobile communication system, a 5G new radio (NR) system, or other novel mobile communication systems in the future. It is to be also noted that a direct link in the embodiments of the present disclosure may alternatively be referred to as a side link or a direct communication link.

The first UE 11, the second UE 12 and the third UE 13 in the embodiment of the present disclosure are an entity on a user side, for instance, a mobile phone, configured to receive or transmit signals. The UE may alternatively be referred to as a terminal, user equipment (UE), a mobile station (MS), a mobile terminal (MT), etc. The terminal may be a vehicle having a communication function, an intelligent vehicle, a mobile phone, a wearable device, Pad, a computer having a wireless transceiving function, a virtual reality (VR) terminal, an augmented reality (AR) terminal, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, etc. The embodiment of the present disclosure does not limit technologies and device forms used by the terminal.

It may be understood that the communication system described in the embodiment of the present disclosure is intended to describe the technical solution of the embodiment of the present disclosure more clearly, instead of limiting the technical solution provided by the embodiment of the present disclosure. Those of ordinary skill in the art may know that the technical solution provided by the embodiment of the present disclosure is also applicable to similar technical problems with evolution of a system architecture and emergence of new service scenarios.

A method and device for establishing a direct link according to the present disclosure will be described in detail with reference to the accompanying drawings below.

It is to be noted that, in an embodiment of the present disclosure, the second UE transmits a discovery message to the first UE and the third UE respectively. The discovery message is protected with a key used for a discovery phase, where the key includes at least one of a key for confidentiality protection or a key for integrity protection. A discovery procedure and a relay selection procedure are performed, such that the first UE and the third UE may discover each other and select the second UE as relay UE. Then, the first UE may transmit a direct communication request to the second UE so as to establish a PC5 link between the first UE and the second UE, and negotiate a first key shared by the first UE and the second UE during the procedure of establishing the PC5 link. The first key is configured to protect information transmitted between the first UE and the second UE. The second UE may transmit a direct communication request to the third UE so as to establish a PC5 link between the second UE and the third UE, and negotiate a second key shared by the second UE and the third UE during the procedure of establishing the PC5 link. The second key is configured to protect information transmitted between the second UE and the third UE. Then, an end-to-end link via the second UE may be established between the first UE and the third UE through the method described in the embodiment. It is to be noted that the first UE is source UE, the second UE is layer-2 relay UE, and the third UE is target UE.

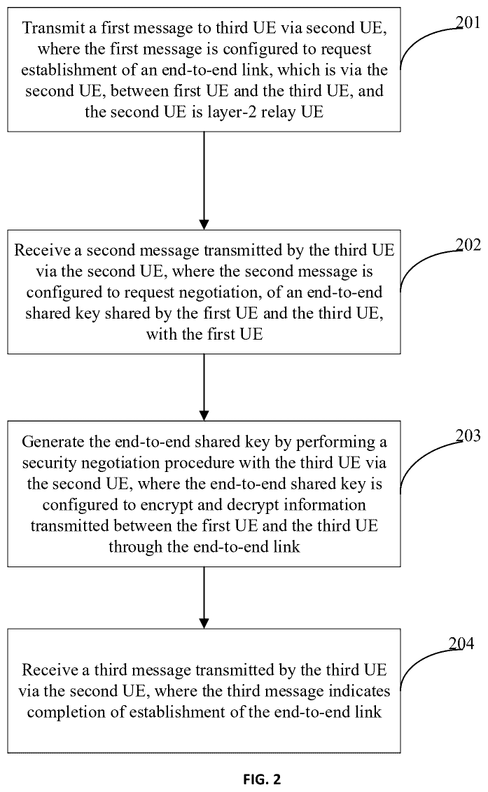

FIG. 2 is a flowchart of a method for establishing a direct link according to an embodiment of the present disclosure.

As shown in FIG. 2, the method is performed by first UE. The method may include, but is not limited to, steps S201, S202, S203 and S204.

In step S201, a first message is transmitted to third UE via second UE. The first message is configured to request establishment of an end-to-end link, which is via the second UE, between the first UE and the third UE. The second UE is layer-2 relay UE.

In an embodiment of the present disclosure, the first message transmitted by the first UE to the second UE is encrypted with a first key. The first key is generated through negotiation between the first UE and the second UE during establishment of a PC5 link between the first UE and the second UE, and is shared by the first UE and the second UE.

In an embodiment of the present disclosure, for security reasons, the first message transmitted by the first UE to the second UE is protected through encryption. The first UE may encrypt the first message through the first key. The first key is generated through negotiation between the first UE and the second UE during establishment of a PC5 link between the first UE and the second UE. For instance, the first UE and the second UE generate the first key (for instance, a ProSe security key) through a direct authentication and key generation procedure during establishing the PC5 link between the first UE and the second UE, and store the generated first key locally. After the second UE receives the first message, the second UE may decrypt the first message with the first key locally stored. Reference may be made to FIG. 5 for a procedure of establishing the PC5 link between the first UE and the second UE, which will not be repeated.

In an embodiment of the present disclosure, the first message may include a destination identity (ID). The destination ID is a layer-2 ID of the third UE or a layer-2 ID of the second UE.

For instance, after the second UE receives the first message including the layer-2 ID of the third UE as the destination ID, the second UE determines to forward the first message to the third UE (that is, target UE) according to the destination ID.

For another instance, after the second UE receives the first message including the layer-2 ID of the second UE as the destination ID, the second UE determines to forward the first message to the third UE (that is, target UE) according to user ID information. The user ID information includes at least one of: a first UE identity, a second UE identity, or a third UE identity. That is, the user ID information may include at least one of a source UE identity, a relay UE identity, or a target UE identity. In the embodiment, the first UE identity is the source UE identity, the second UE identity is the relay UE identity, and the third UE identity is the target UE identity. The second UE determines to forward the first message to corresponding target UE, that is, the third UE, according to the user ID information.

In an embodiment of the present disclosure, the first UE may transmit the user ID information to the second UE.

For instance, in an embodiment of the present disclosure, the first UE may be the source UE, the second UE may be the relay UE, and the third UE may be the target UE.

In step S202, a second message transmitted by the third UE via the second UE is received. The second message is configured to request negotiation, of an end-to-end shared key shared by the first UE and the third UE, with the first UE.

In step S203, the end-to-end shared key is generated by performing a security negotiation procedure with the third UE via the second UE. The end-to-end shared key is configured to encrypt and decrypt information transmitted between the first UE and the third UE through the end-to-end link.

The first UE performs the security negotiation procedure with the third UE via the second UE. During the security negotiation procedure performed by the first UE and the third UE, the second UE needs to forward messages transmitted by the first UE and the third UE, so as to complete the security negotiation procedure.

In an embodiment of the present disclosure, the step that the end-to-end shared key is generated by performing the security negotiation procedure with the third UE via the second UE includes the following step: the end-to-end shared key is generated by performing an IKEv2 authentication procedure with the third UE via the second UE.

In an embodiment of the present disclosure, after the first UE receives the second message, the first UE may perform the security negotiation procedure with the third UE, such that the end-to-end link is established. During the security negotiation procedure, in order to ensure security, the IKEv2 authentication procedure may be performed to authenticate the first UE and the third UE. For instance, the authentication may be performed through identity authentication, key distribution authentication, or IPsec establishment. After authentication, the first UE and the third UE may generate and share an end-to-end shared security key.

In step S204, a third message transmitted by the third UE via the second UE is received. The third message indicates the completion of the establishment of the end-to-end link.

In an embodiment of the present disclosure, the third message may be encrypted with the end-to-end shared key.

In an embodiment of the present disclosure, the third message may be encrypted with the end-to-end shared key and the first key.

In the method for establishing the direct link according to the embodiment of the present disclosure, the first UE firstly transmits an end-to-end link establishment request to the third UE through the second UE. After feedback from the third UE is obtained, the first UE may negotiate with the third UE to share a shared key for the end-to-end link. Then, the negotiation procedure is performed to generate the shared key until the completion of the establishment of the end-to-end link is indicated. Based on this, information transmitted for communication between the first UE (that is, source UE) and the third UE (that is, target UE) is encrypted and decrypted through the shared key. In this way, information leakage caused by an attack on the layer-2 relay UE is avoided, and a secure direct link is established. In the present disclosure, the layer-2 relay UE participates in the procedure of establishing the direct link, such that a secure direct link can be effectively established.

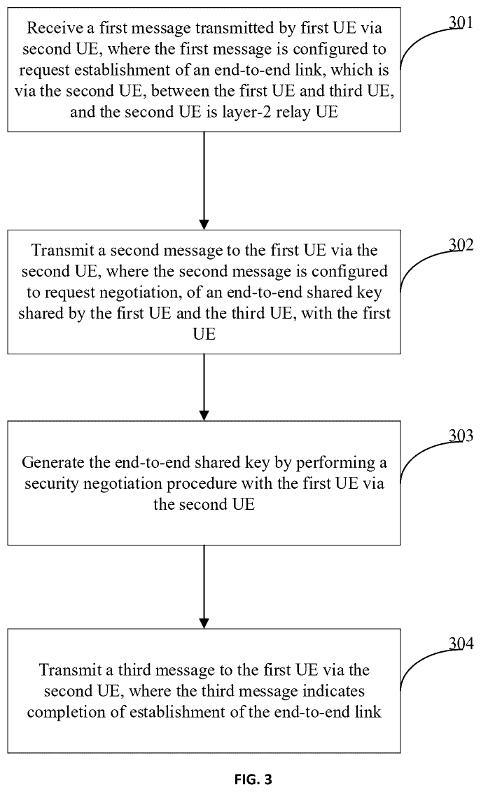

FIG. 3 is a flowchart of a method for establishing a direct link according to an embodiment of the present disclosure.

As shown in FIG. 3, the method is performed by third UE. The method may include, but is not limited to, steps S301, S302, S303, and S304.

In step S301, a first message transmitted by first UE via second UE is received. The first message is configured to request the establishment of an end-to-end link, which is via the second UE, between the first UE and third UE. The second UE is layer-2 relay UE.

In an embodiment of the present disclosure, the first message received by the third UE from the second UE is encrypted with a second key. The second key is generated through negotiation between the third UE and the second UE during the establishment of a PC5 link between the third UE and the second UE, and is shared by the third UE and the second UE.

In an embodiment of the present disclosure, the first message may include a destination identity (ID). The destination ID is a layer-2 ID of the third UE or a layer-2 ID of the second UE.

In an embodiment of the present disclosure, the first UE may transmit user ID information to the second UE.

In an embodiment of the present disclosure, the third UE may further receive user ID information transmitted by the second UE. The user ID information includes at least one of: a source UE identity, a relay UE identity, or a target UE identity.

In step S302, a second message is transmitted to the first UE via the second UE. The second message is configured to request negotiation, of an end-to-end shared key shared by the first UE and the third UE, with the first UE.

The end-to-end shared key is configured to encrypt and decrypt information transmitted between the first UE and the third UE through the end-to-end link.

In step S303, the end-to-end shared key is generated by performing a security negotiation procedure with the first UE via the second UE.

In an embodiment of the present disclosure, the step that the end-to-end shared key is generated by performing the security negotiation procedure with the first UE via the second UE includes the following step: the end-to-end shared key is generated by performing an IKEv2 authentication procedure with the first UE via the second UE.

In step S304, a third message is transmitted to the first UE via the second UE. The third message indicates the completion of the establishment of the end-to-end link.

In an embodiment of the present disclosure, the third message is encrypted with the end-to-end shared key.

In an embodiment of the present disclosure, the third message is encrypted with the end-to-end shared key and the second key.

In the method for establishing the direct link according to the embodiment of the present disclosure, the third UE receives a link establishment request transmitted by the first UE. Then, negotiation is performed with the first UE, and the end-to-end shared key is generated by performing the IKEv2 authentication procedure. Finally, the completion of the establishment of the end-to-end link is indicated to the first UE. Based on this, the first UE (that is, source UE) and the third UE (that is, target UE) may be in direct communication with each other based on the end-to-end link, may generate the end-to-end shared key by performing the IKEv2 authentication procedure, and may protect communication information with the shared key. Thus, security of communication between the source UE and the target UE is provided, information leakage caused by an attack on the relay UE is avoided, and a secure direct link is established. In the present disclosure, the layer-2 relay UE participates in the procedure of establishing the direct link, such that a secure direct link can be effectively established.

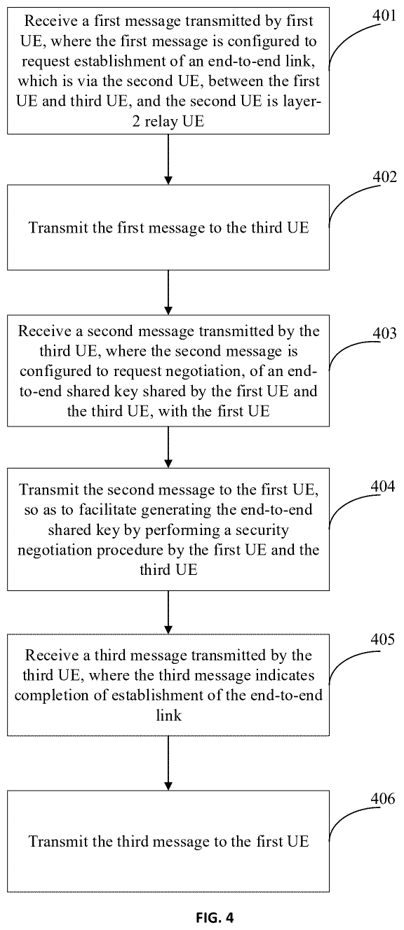

FIG. 4 is a flowchart of a method for establishing a direct link according to an embodiment of the present disclosure.

As shown in FIG. 4, the method is performed by second UE. The method may include, but is not limited to, steps S401 to S406.

In step S401, a first message transmitted by first UE is received. The first message is configured to request the establishment of an end-to-end link, which is via the second UE, between the first UE and third UE. The second UE is layer-2 relay UE.

In an embodiment of the present disclosure, the second UE stores a pre-configured long-term credential related to a relay service code (RSC)/proximity service (ProSe) code. The long-term credential is configured to generate a first key and a second key.

In an embodiment of the present disclosure, a ProSe key request is transmitted to a proximity key management function (PKMF) network element or a direct discovery name management function (DDNMF) network element of the second UE. The ProSe key request includes a credential ID and an RSC/ProSe code for requesting a long-term credential related to the credential ID and the RSC/ProSe code from the PKMF network element or the DDNMF network element. The long-term credential is configured to generate the first key and the second key. Moreover, a ProSe key response is received from the PKMF network element or the DDNMF network element. The ProSe key response carries the long-term credential.

In an embodiment of the present disclosure, the first message may include a destination identity (ID). The destination ID is a layer-2 ID of the third UE or a layer-2 ID of the second UE.

For instance, after the second UE receives the first message including the layer-2 ID of the third UE as the destination ID, the second UE determines to forward the first message to the third UE (that is, target UE) according to the destination ID.

For another instance, after the second UE receives the first message including the layer-2 ID of the second UE as the destination ID, the second UE determines to forward the first message to the third UE (that is, target UE) according to user ID information. The user ID information includes at least one of: a first UE identity, a second UE identity, or a third UE identity. That is, the user ID information may include at least one of a source UE identity, a relay UE identity, or a target UE identity. In the embodiment, the first UE identity is the source UE identity, the second UE identity is the relay UE identity, and the third UE identity is the target UE identity. The second UE determines to forward the first message to corresponding target UE, that is, the third UE, according to the user ID information.

In an embodiment of the present disclosure, the first UE may transmit the user ID information to the second UE.

In an embodiment of the present disclosure, the first message received by the second UE from the first UE is encrypted with a first key. The first key is generated through negotiation between the first UE and the second UE during the establishment of a PC5 link between the first UE and the second UE, and is shared by the first UE and the second UE. The method further includes the following step: the first message received from the first UE is decrypted based on the first key.

In an embodiment of the present disclosure, for security reasons, the first message transmitted by the first UE to the second UE is protected through encryption. The first UE may encrypt the first message using the first key. The first key is generated through negotiation between the first UE and the second UE during the establishment of the PC5 link between the first UE and the second UE. For instance, the first UE and the second UE generate the first key (for instance, a ProSe security key) through a direct authentication and key generation procedure while establishing the PC5 link between the first UE and the second UE, and the first UE and the second UE store the generated first key locally. After the second UE receives the first message, the second UE may decrypt the first message with the first key locally stored. Reference may be made to FIG. 5 for a procedure of establishing the PC5 link between the first UE and the second UE, which will not be repeated.

In step S402, the first message is transmitted to the third UE.

In step S403, a second message transmitted by the third UE is received. The second message is configured to request negotiation, of an end-to-end shared key shared by the first UE and the third UE, with the first UE.

The end-to-end shared key is configured to encrypt and decrypt information transmitted between the first UE and the third UE through the end-to-end link.

In step S404, the second message is transmitted to the first UE, so as to facilitate generating the end-to-end shared key by performing a security negotiation procedure by the first UE and the third UE.

In an embodiment of the present disclosure, the first message transmitted by the second UE to the third UE is encrypted with a second key. The second key is generated through negotiation between the third UE and the second UE during the establishment of a PC5 link between the third UE and the second UE, and is shared by the third UE and the second UE. The method further includes the following step: the first message obtained from the first UE is encrypted based on the second key.

In an embodiment of the present disclosure, for security reasons, after the second UE receives the first message, the second UE may encrypt the first message with the second key and forward the encrypted first message to the third UE. The second key is generated through negotiation between the second UE and the third UE during the establishment of a PC5 link between the second UE and the third UE. For instance, the second UE and the third UE may generate the second key (for instance, a ProSe security key) through a direct authentication and key generation procedure while establishing the PC5 link between the second UE and the third UE, and store the second key locally. After the third UE receives the first message, the third UE may decrypt the encrypted first message with the second key locally stored. Reference may be made to FIG. 5 for a procedure of establishing the PC5 link between the second UE and the third UE, which will not be repeated.

In step S405, a third message transmitted by the third UE is received. The third message indicates the completion of the establishment of the end-to-end link.

In an embodiment of the present disclosure, the third message received by the second UE from the third UE is encrypted with the end-to-end shared key and the second key. The method may further include the following step: the third message received from the third UE is decrypted based on the second key.

In step S406, the third message is transmitted to the first UE.

In an embodiment of the present disclosure, the third message transmitted by the second UE to the first UE is encrypted with the end-to-end shared key and the first key. The method may further include the following step: the third message obtained from the third UE is encrypted based on the first key.

In the method for establishing the direct link according to the embodiment of the present disclosure, the second UE assists in the interaction between the first UE and the third UE. That is, the second UE receives the link establishment request transmitted by the first UE, and forwards the link establishment request to the third UE; receives the second message transmitted by the third UE and forwards the second message to the first UE, so as to facilitate the first UE and the third UE to generate the end-to-end shared key by performing the security negotiation procedure; and receives the third message transmitted by the third UE and forwards the third message to the first UE. In this way, information transmitted for communication between the first UE (that is, source UE) and the third UE (that is, target UE) is encrypted and decrypted through the shared key. In this way, information leakage caused by an attack on the layer-2 relay UE is avoided, and a secure direct link is established. In the present disclosure, the layer-2 relay UE participates in the procedure of establishing the direct link, such that a secure direct link can be effectively established.

In order to more conveniently and comprehensively understand the method for establishing the direct link according to the present disclosure, with reference to FIG. 5, FIG. 5 is a schematic diagram of a method for establishing a direct link according to the present disclosure.

As shown in FIG. 5, it is assumed that both target UE and source UE may pre-configure a same long-term credential and long-term credential ID.

In step 500, relay UE provides a security key for a discovery procedure for source UE and target UE, before a discovery and link establishment procedure.

In step 501, a discovery and relay selection procedure is performed among the source UE, the target UE, and the relay UE, using the security key for the discovery procedure.

It is assumed that after the discovery procedure and the relay selection procedure, the source UE and the target UE discover each other and select a same layer-2 relay UE.

In step 502, the source UE transmits a direct communication request to the layer-2 relay UE. The direct communication request includes a long-term credential ID, a user information ID, a security function of the source UE, an RSC/ProSe code of a 5G ProSe end-to-end (U2U) relay service and a first random number (nonce 1). In a case where the source UE has Knrp (that is, a first key shared by the source UE and a layer-2 relay UE with which the source UE tries to be in communication) of the layer-2 relay UE, this message may further include Knrp ID. The Knrp ID corresponds to the Knrp. In this way, the layer-2 relay UE may know Knrp possessed by the source UE after receiving the message.

The user information ID may include at least one of source user information, target user information, or relay user information.

In step 503a, in a case where the layer-2 relay UE already has a long-term credential identified by the long-term credential ID, steps 3a and 3b are skipped. Otherwise, the layer-2 relay UE transmits a ProSe Key Request message to a 5G PKMF/DDNMF network element of the layer-2 relay UE. This ProSe Key Request message may include a layer-2 relay UE identity, the long-term credential ID, and the RSC/ProSe code, and indicates that the layer-2 relay UE requests the long-term credential.

In step 503b, once the ProSe Key Request message is received, the 5G PKMF/DDNMF network element of the relay UE may check, according to a relay identity of the layer-2 relay UE and the received RSC/ProSe code, whether the layer-2 relay UE is authorized to provide relay/ProSe service. In a case where authorization information of the layer-2 relay UE is not available locally, the 5G PKMF/DDNMF network element may request the authorization information from unified data management (UDM) of the layer-2 relay UE (not shown in the figure). In a case where the layer-2 relay UE is authorized to provide relay service according to ProSe subscription data, the 5G PKMF/DDNMF network element of the relay UE transmits the long-term credential to the layer-2 relay UE.

The layer-2 relay UE identity may be set as a ProSe application ID of the layer-2 relay UE, a subscription concealed identifier (SUCI) of the layer-2 relay UE, or user ID information (User Info ID) of the layer-2 relay UE.

The long-term credential may also be pre-configured in the layer-2 relay UE. In this case, steps 3a and 3b are skipped.

In step 504, the layer-2 relay UE may start a direct authentication and key generation procedure with the source UE, so as to generate the Knrp. In a case where the direct communication request includes the Knrp ID, the step 4 is skipped, and corresponding Knrp may be determined directly according to the Knrp ID.

In step 505, the layer-2 relay UE may derive a session key (Knrp-sess) from the Knrp according to a PC5 security policy specified in a protocol, and then derive a confidentiality key (NRPEK) (in a case of being used) and an integrity key (NRPIK) (in a case of being used). The layer-2 relay UE transmits a direct security mode command message to the source UE. The direct security mode command message includes a selected security algorithm and a second random number (nonce 2), and may be protected as specified in a protocol.

In step 506, according to the protocol, the source UE responds to the layer-2 relay UE through a direct security mode complete message.

Through steps 502-506, a PC5 link is established between the source UE and the relay UE, and a first key is generated through negotiation, such that information transmitted between the source UE and the relay UE may be protected with the first key.

In step 507, the layer-2 relay UE transmits a direct communication request to the target UE. The direct communication request includes a long-term credential ID, a user information ID, a security function of the relay UE, an RSC/ProSe code of 5G ProSe U2U relay service, and a nonce 1′. In a case where the layer-2 relay UE has Knrp′ (a second key) of the target UE with which the layer-2 relay UE tries to be in communication, this message may further include Knrp ID′.

In step 508, the target UE may start a direct authentication and key generation procedure with the layer-2 relay UE, so as to generate the Knrp′. In a case where the direct communication request includes the Knrp ID′, the step 8 is skipped.

In step 509, the target UE derives a session key (Knrp-sess′) from the Knrp′ according to a PC5 security policy specified in a protocol, and then derives a confidentiality key (NRPEK′) (in a case of being used) and an integrity key (NRPIK′) (in a case of being used). The target UE transmits a direct security mode command message to the layer-2 relay UE. The direct security mode command message includes a selected security algorithm and nonce 2′, and may be protected as specified in a protocol.

In step 510, the layer-2 relay UE responds to a direct security mode complete message specified in TS 33.536.

In step 511, once the direct security mode complete message is received from the layer-2 relay UE, the target UE transmits a direct communication accept message to the layer-2 relay UE.

Through steps 507-511, a PC5 link is established between the target UE and the relay UE, and the second key is generated through negotiation, such that information transmitted between the target UE and the relay UE may be protected with the second key.

In step 512, once the direct communication accept message is received, the layer-2 relay UE transmits the direct communication accept message to the source UE.

In step 513, the source UE transmits an end-to-end direct communication request to the target UE. The end-to-end direct communication request is forwarded by the layer-2 relay UE. In a first hop (that is, the PC5 link between the source UE and the layer-2 relay UE), the end-to-end direct communication request is protected by NRPIK/NRPEK. In a second hop (that is, the PC5 link between the layer-2 relay UE and the target UE), the end-to-end direct communication request is protected by NRPIK′/NRPEK′.

A destination ID of the end-to-end direct communication request may be set as a layer-2 ID of the target UE or a layer-2 ID of the relay UE. In a case where the destination ID is set as the layer-2 ID of the relay UE, the relay UE determines the destination ID according to the user information ID, so as to forward the end-to-end direct communication request to corresponding target UE.

In step 514, the target UE may start a security negotiation procedure with the source UE, such that an end-to-end IPSec connection may be established, which may be implemented by performing an IKEv2 identity authentication procedure. After IKEv2 authentication, the source UE and the target UE generate an end-to-end shared security key.

In step 515, the target UE responds to an end-to-end direct communication accept forwarded by the layer-2 relay UE. The end-to-end direct communication accept is protected by an end-to-end security key generated in step 14 and a prose security key (that is, NRPIK/NRPEK and NRPIK′/NRPEK′) generated in step 2-12.

In step 516, a secure L2 PC5 link is established between the source UE and the target UE through the layer-2 relay UE. The source UE and the target UE may start communication. In communication, the layer-2 relay UE relays service data between the source UE and the target UE.

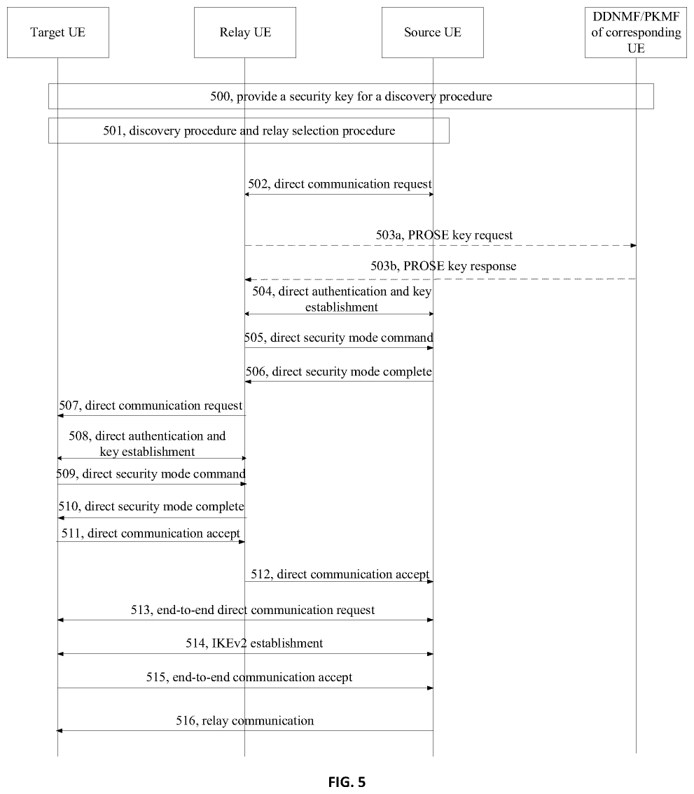

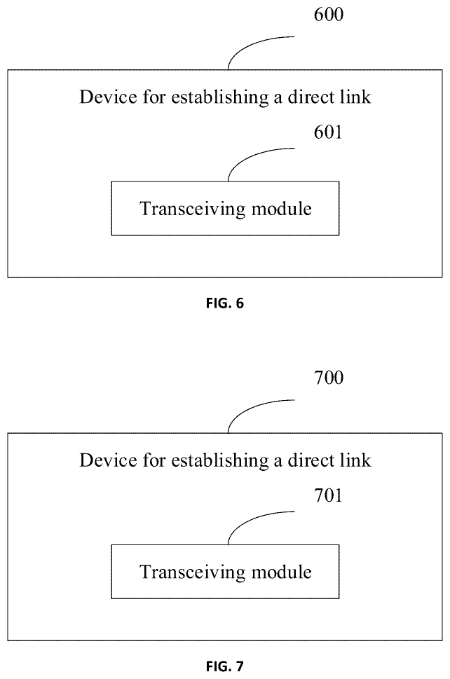

FIG. 6 is a structural diagram of a device for establishing a direct link according to an embodiment of the present disclosure.

As shown in FIG. 6, the device 600 for establishing the direct link is configured for first UE, and includes a transceiving module 601. The transceiving module 601 is configured to: transmit a first message to third UE via second UE, where the first message is configured to request the establishment of an end-to-end link, which is via the second UE, between the first UE and the third UE, and the second UE is layer-2 relay UE; receive a second message transmitted by the third UE via the second UE, where the second message is configured to request negotiation, of an end-to-end shared key shared by the first UE and the third UE, with the first UE; generate the end-to-end shared key by performing a security negotiation procedure with the third UE via the second UE; and receive a third message transmitted by the third UE via the second UE, where the third message indicates completion of establishment of the end-to-end link.

The end-to-end shared key is configured to encrypt and decrypt information transmitted between the first UE and the third UE through the end-to-end link.

In an embodiment of the present disclosure, the first message transmitted by the first UE to the second UE is encrypted with a first key. The first key is generated through negotiation between the first UE and the second UE during establishment of a PC5 link between the first UE and the second UE, and is shared by the first UE and the second UE.

In an embodiment of the present disclosure, generating the end-to-end shared key by performing the security negotiation procedure with the third UE via the second UE includes: generating the end-to-end shared key by performing an Internet Key Exchange Vision2 (IKEv2) authentication procedure with the third UE via the second UE.

In an embodiment of the present disclosure, the third message is encrypted with the end-to-end shared key.

In an embodiment of the present disclosure, the third message is encrypted with the end-to-end shared key and the first key.

In an embodiment of the present disclosure, the device 600 is further configured to transmit user ID information to the second UE. The user ID information includes at least one of: a source UE identity, a relay UE identity, or a target UE identity.

In the device for establishing the direct link according to the embodiment of the present disclosure, the first UE first transmits an end-to-end link establishment request to the third UE through the second UE. After feedback from the third UE is obtained, the first UE may negotiate with the third UE to share a shared key for the end-to-end link. Then, the negotiation procedure is performed to generate the shared key until the completion of the establishment of the end-to-end link is indicated. Based on this, the established end-to-end link may be used for direct communication between UEs, and communication contents may be encrypted and decrypted with the shared key. Thus, security of communication between pieces of UE is provided, information leakage caused by an attack on the relay UE is avoided, and a secure direct link is established. In the present disclosure, the layer-2 relay UE participates in a procedure of establishing the direct link, such that a secure direct link can be effectively established.

FIG. 7 is a structural diagram of a device for establishing a direct link according to an embodiment of the present disclosure.

As shown in FIG. 7, the device 700 for establishing the direct link is configured for third UE, and includes a transceiving module 701. The transceiving module 701 is configured to: receive a first message transmitted by first UE via second UE, where the first message is configured to request the establishment of an end-to-end link, which is via the second UE, between the first UE and the third UE, and the second UE is layer-2 relay UE; transmit a second message to the first UE via the second UE, where the second message is configured to request negotiation, of an end-to-end shared key shared by the first UE and the third UE, with the first UE; generate the end-to-end shared key by performing a security negotiation procedure with the first UE via the second UE; and transmit a third message to the first UE via the second UE, where the third message indicates completion of establishment of the end-to-end link.

In an example, the end-to-end shared key is configured to encrypt and decrypt information transmitted between the first UE and the third UE through the end-to-end link.

In an embodiment of the present disclosure, the first message received by the third UE from the second UE is encrypted with a second key. The second key is generated through negotiation between the third UE and the second UE during the establishment of a PC5 link between the third UE and the second UE, and is shared by the third UE and the second UE.

In an embodiment of the present disclosure, the transceiving module 701 is further configured to: generate the end-to-end shared key by performing an Internet Key Exchange Vision2 (IKEv2) authentication procedure with the first UE via the second UE.

In an embodiment of the present disclosure, the third message is encrypted with the end-to-end shared key.

In an embodiment of the present disclosure, the third message is encrypted with the end-to-end shared key and the second key.

In an embodiment of the present disclosure, the device 700 is further configured to: receive user ID information transmitted by the second UE. The user ID information includes at least one of: a source UE identity, a relay UE identity, or a target UE identity.

In the device for establishing the direct link according to the embodiment of the present disclosure, the third UE receives a link establishment request transmitted by the first UE. Then, negotiation is performed with the first UE, and the end-to-end shared key is generated by performing the IKEv2 authentication procedure. Finally, the completion of the establishment of the end-to-end link is indicated to the first UE. Based on this, the pieces of UE may be in direct communication with each other based on the end-to-end link, may generate the end-to-end shared key by performing the IKEv2 authentication procedure, and may protect communication information with the shared key. Thus, security of communication between the pieces of UE is provided, information leakage caused by an attack on the relay UE is avoided, and a secure direct link is established. In the present disclosure, the layer-2 relay UE participates in the procedure of establishing the direct link, such that a secure direct link can be effectively established.

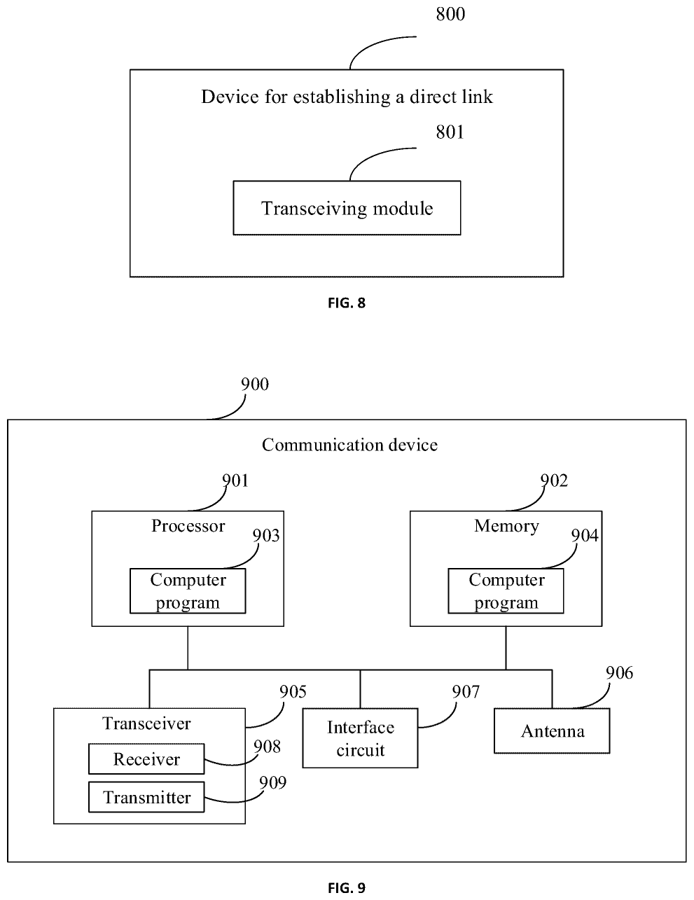

FIG. 8 is a structural diagram of a device for establishing a direct link according to an embodiment of the present disclosure.

As shown in FIG. 8, the device 800 for establishing the direct link is configured for second UE, and includes a transceiving module 801. The transceiving module 801 is configured to: receive a first message transmitted by first UE, where the first message is configured to request establishment of an end-to-end link, which is via the second UE, between the first UE and third UE, and the second UE is layer-2 relay UE; transmit the first message to the third UE; receive a second message transmitted by the third UE, where the second message is configured to request negotiation, of an end-to-end shared key shared by the first UE and the third UE, with the first UE; transmit the second message to the first UE, so as to facilitate generating the end-to-end shared key by performing a security negotiation procedure by the first UE and the third UE; receive a third message transmitted by the third UE, where the third message indicates completion of establishment of the end-to-end link; and transmit the third message to the first UE.

In an example, the end-to-end shared key is configured to encrypt and decrypt information transmitted between the first UE and the third UE through the end-to-end link.

In an embodiment of the present disclosure, the transceiving module 801 is further configured to: decrypt the first message received from the first UE based on the first key.

In an embodiment of the present disclosure, the first message transmitted by the second UE to the third UE is encrypted with a second key. The second key is generated through negotiation between the third UE and the second UE during the establishment of a PC5 link between the third UE and the second UE, and is shared by the third UE and the second UE. The transceiving module 801 is further configured to: encrypt, based on the second key, the first message obtained from the first UE.

In an embodiment of the present disclosure, the transceiving module 801 is further configured to: decrypt, based on the second key, the third message received from the third UE.

In an embodiment of the present disclosure, the third message transmitted by the second UE to the first UE is encrypted with the end-to-end shared key and the first key. The device 800 is further configured to: encrypt, based on the first key, the third message obtained from the third UE.

In an embodiment of the present disclosure, the second UE stores a pre-configured long-term credential related to a relay service code (RSC)/proximity service (ProSe) code. The long-term credential is configured to generate the first key and the second key.

In an embodiment of the present disclosure, the device 800 is further configured to: transmit a ProSe key request to a proximity key management function (PKMF) network element or a direct discovery name management function (DDNMF) network element of the second UE, where the ProSe key request includes a credential ID and an RSC/ProSe code for requesting a long-term credential related to the credential ID and the RSC/ProSe code from the PKMF network element or the DDNMF network element, and the long-term credential is configured to generate the first key and the second key; and receive a ProSe key response from the PKMF network element or the DDNMF network element, where the ProSe key response carries the long-term credential.

In the device for establishing the direct link according to the embodiment of the present disclosure, the second UE assists in the interaction between the first UE and the third UE. That is, the second UE receives the link establishment request transmitted by the first UE, and forwards the link establishment request to the third UE; receives the second message transmitted by the third UE and forwards the second message to the first UE, so as to facilitate the first UE and the third UE to generate the end-to-end shared key by performing the security negotiation procedure; and receives the third message transmitted by the third UE and forwards the third message to the first UE. In this way, information transmitted for communication between the first UE (that is, source UE) and the third UE (that is, target UE) is encrypted and decrypted through the shared key. In this way, information leakage caused by an attack on the layer-2 relay UE is avoided, and a secure direct link is established. In the present disclosure, the layer-2 relay UE participates in the procedure of establishing the direct link, such that a secure direct link can be effectively established.

With reference to FIG. 9, FIG. 9 is a schematic structural diagram of a communication device 900 according to an embodiment of the present disclosure. The communication device 900 may be a network device, or a terminal, or a chip, a chip system, or a processor that enables the network device to implement the method in the disclosure, or a chip, a chip system, or a processor that enables the terminal to implement the method in the disclosure. The communication device 900 may be configured to implement the method described in the method example. Reference may be made to the description in the method embodiment for details.

The communication device 900 may include one or more processors 901. The processor 901 may be a general-purpose processor, a special-purpose processor, etc. For instance, the processor 901 may be a baseband processor or a central processing unit. The baseband processor may be configured to process a communication protocol and communication data. The central processing unit may be configured to control the communication device 900 (for instance, a base station, a baseband chip, a terminal, a terminal chip, a distributed unit (DU), or a centralized unit (CU)), execute a computer program, and process data of the computer program.

In an example, the communication device 900 may further include one or more memories 902. The memory 902 may store a computer program 904. The processor 901 executes the computer program 904, such that the communication device 900 perform the method described in the method embodiment. In an example, the memory 902 may further store data. The communication device 900 and the memory 902 may be arranged separately or integrated with each other.

In an example, the communication device 900 may further include a transceiver 905 and an antenna 906. The transceiver 905 may be referred to as a transceiving unit, a transceiving machine, a transceiving circuit, etc., and is configured to achieve a transceiving function. The transceiver 905 may include a receiver 908 and a transmitter 909. The receiver 908 may be referred to as a reception machine or a reception circuit, and is configured to achieve a reception function. The transmitter 909 may be referred to as a transmission machine or a transmission circuit, and is configured to achieve a transmission function.

In an example, the communication device 900 may further include one or more interface circuits 907. The interface circuit 907 is configured to receive code instructions and transmit the code instructions to the processor 901. The processor 901 runs the code instructions, such that the method described in the method embodiment is performed by the communication device 900.

In an implementation, the processor 901 may include a transceiver (not shown) configured to achieve reception and transmission functions. For instance, the transceiver may be a transceiving circuit, an interface, or an interface circuit. The transceiving circuit, the interface or the interface circuit configured to achieve the reception and transmission functions may be separated or integrated. The transceiving circuit, the interface or the interface circuit may be configured to read and write codes/data. Alternatively, the transceiving circuit, the interface or the interface circuit may be configured to transmit or transfer a signal.

In an implementation, the processor 901 may store a computer program 903. The computer program 903 runs on the processor 901, such that the communication device 900 may perform the method described in the method embodiment. The computer program 903 may be cured in the processor 901. In this case, the processor 901 may be implemented by hardware.

In an implementation, the communication device 900 may include a circuit (not shown). The circuit may achieve a transmission or reception or communication function in the method embodiment. The processor and the transceiver described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and the transceiver may also be manufactured through various IC process technologies, such as a complementary metal oxide semiconductor (CMOS), an n-metal oxide semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The communication device 900 in the description of the embodiments may be a network device or a terminal, which does not limit the scope of the communication device 900 described in the present disclosure. A structure of the communication device 900 may not be limited by FIG. 9. The communication device 900 may be an independent device or may be part of a large device. For instance, the communication device 900 may be:
(1) a separate integrated circuit (IC), a chip, a chip system, or a subsystem;
(2) a set having one or more ICs, where the set of IC may also include a storage component configured to store data and a computer program;
(3) an ASIC, for instance, a modem;
(4) a module that may be embedded in other devices;
(5) a receiver, a terminal, an intelligent terminal, a cellular phone, a radio device, a handset, a mobile unit, an in-vehicle device, a network device, a cloud device, an artificial intelligence device, etc.; and
(6) other device.

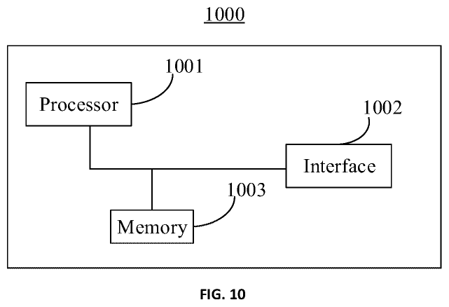

In a case that the communication device 900 may be a chip or a chip system, reference may be made to a schematic structural diagram of a chip shown in FIG. 10. The chip 1000 shown in FIG. 10 includes a processor 1001 and an interface 1002. There may be one or more processors 1001. Further, there may be more than one interface 1002.

In an example, the chip 1000 further includes a memory 1003. The memory 1003 is configured to store a computer program and data that are necessary.

Those skilled in the art may further understand that various illustrative logical blocks and steps listed in the embodiments of the present disclosure may be implemented by electronic hardware, computer software, or a combination of both. Whether the function is achieved by hardware or software depends on specific applications and design requirements of an entire system. Those skilled in the art may use different methods to achieve the functions for each particular application, but such implementation is not considered to fall beyond the protection scope of the embodiments of the present disclosure.

The present disclosure further provides a non-transitory computer-readable storage medium. The non-transitory computer-readable storage medium stores instructions. When the instructions are executed by a computer, functions of any one of the method embodiments are achieved.

The present disclosure further provides a computer program product. When the computer program product is executed by a computer, functions of any one of the method embodiments are achieved.

The embodiments in the disclosure may be partially or completely implemented with software, hardware, firmware or any combinations of them. During implementation with software, the embodiments may be partially or completely implemented in a form of a computer program product. The computer program product includes one or more computer programs. When the computer program is loaded and executed on the computer, flows or functions according to the embodiments of the present disclosure are partially or completely generated. The computer may be a general-purpose computer, a special-purpose computer, a computer network, or another programmable device. The computer program may be stored in a non-transitory computer-readable storage medium or transmitted from one non-transitory computer-readable storage medium to another non-transitory computer-readable storage medium. For instance, the computer program may be transmitted from a website, a computer, a server or a data center to another website, another computer, another server or another data center in a wired manner (for instance, through a coaxial cable, an optical fiber, or a digital subscriber line (DSL)) or a wireless manner (for instance, through infrared waves, radio, or microwaves). The non-transitory computer-readable storage medium may be any available medium that may be accessed by the computer or a data storage device such as an integration server and data center that includes one or more available medium. The available medium may be a magnetic medium (for instance, a floppy disk, a hard disk, or a magnetic tape), an optical medium (for instance, a high-density digital video disc (DVD)), a semiconductor medium (for instance, a solid state disk (SSD)), etc.

The present disclosure provides a method for establishing a direct link, a device, and a storage medium. The first UE first requests establishment of the end-to-end link, which is via the second UE, for communication between the first UE and the third UE. After receiving the shared key fed back by the third UE, the first UE generates the end-to-end shared key together with the third UE, and obtains the message indicating the completion of establishment of the end-to-end link. Based on this, information transmitted for communication between the first UE (that is, source UE) and the third UE (that is, target UE) is encrypted and decrypted through the shared key. In this way, information leakage caused by an attack on the layer-2 relay UE is avoided, and a secure direct link is established. In the present disclosure, the layer-2 relay UE participates in the procedure of establishing the direct link, such that a secure direct link can be effectively established.

Those of ordinary skill in the art may understand that numerical symbols such as “first” and “second” involved in the present disclosure are only for convenience of description, instead of limiting the scope of the embodiments of the present disclosure, and further indicate a sequence.

“At least one” in the present disclosure may also be described as “one or more,” and “a plurality of” may indicate two, three, four, or more, which are not limited by the present disclosure. In the embodiment of the present disclosure, for a technical feature, technical features in the technical feature are distinguished by “first,” “second,” “third,” “A,” “B,” “C,” “D,” etc. The technical features described by the “first,” “second,” “third,” “A,” “B,” “C” and “D” are not in order of succession or order of size.

A correspondence shown in each table in the present disclosure may be configured or predefined. Values of information in each table are only illustrative, and may be configured to be other values, which are not limited by the present disclosure. When the correspondence between information and all parameters is configured, not all the correspondences indicated in each table have to be configured. For instance, in the tables in the present disclosure, the correspondence shown in some rows does not have to be configured. For another instance, appropriate variation and adjustment may be conducted on the basis of the table, such as splitting and merging. Names of the parameters indicated by headings in the tables may also be other names that may be understood by a communication device, and values or representations of the parameters may also be other values or representations that may be understood by the communication device. The tables may also use other data structures during implementation, such as arrays, queues, containers, stacks, linear tables, pointers, linked lists, trees, graphs, structures, classes, heaps and hash tables.

Predefinition in the present disclosure may be understood as definition, predefinition, storage, prestorage, prenegotiation, preconfiguration, curing, or prefiring.

Those of ordinary skill in the art may understand that the units and algorithm steps of the instances described in connection with the embodiments disclosed in the disclosure may be implemented by electronic hardware, or a combination of computer software and electronic hardware. Whether the functions are executed by hardware or software depends on specific applications and design constraints of the technical solution. Professionals may use different methods to implement the described functions for each specific application, but such implementation should not be considered to fall beyond the scope of the present disclosure.

Those skilled in the art may clearly understand that, for the convenience and conciseness of description, reference may be made to a corresponding procedure in the method embodiment for a specific operation process of the system, device and unit described in the disclosure, which will not be repeated.

What are described are merely implementations of the present disclosure, and are not intended to limit the protection scope of the present disclosure. Any changes or substitutions that may be easily made by those skilled in the art within the technical scope disclosed in the present disclosure should fall within the protection scope of the present disclosure. Thus, the protection scope of the present disclosure should be subject to the protection scope of the claims.

1. A method for establishing a direct link, performed by first user equipment (UE), comprising:
transmitting a first message to third UE via second UE, wherein the first message is configured to request establishment of an end-to-end link, which is via the second UE, between the first UE and the third UE, and the second UE is layer-2 relay UE;
receiving a second message transmitted by the third UE via the second UE, wherein the second message is configured to request negotiation, of an end-to-end shared key shared by the first UE and the third UE, with the first UE;
generating the end-to-end shared key by performing a security negotiation procedure with the third UE via the second UE; and
receiving a third message transmitted by the third UE via the second UE, wherein the third message indicates completion of establishment of the end-to-end link.

2. The method according to claim 1, wherein the first message transmitted by the first UE to the second UE is encrypted with a first key, and the first key is generated through negotiation between the first UE and the second UE during establishment of a PC5 link between the first UE and the second UE and is shared by the first UE and the second UE.

3. The method according to claim 1, wherein the method further comprises at least one of:
generating the end-to-end shared key by performing an Internet Key Exchange Vision2 (IKEv2) authentication procedure with the third UE via the second UE;
encrypting the third message with the end-to-end shared key; or
transmitting user identity (ID) information to the second UE, wherein the user ID information comprises at least one of a source UE identity, a relay UE identity, or a target UE identity.

4. (canceled)

5. The method according to claim 2, wherein the third message is encrypted with the end-to-end shared key and the first key.

6. (canceled)

7. A method for establishing a direct link, performed by third user equipment (UE), comprising:
receiving a first message transmitted by first UE via second UE, wherein the first message is configured to request establishment of an end-to-end link, which is via the second UE, between the first UE and the third UE, and the second UE is layer-2 relay UE;
transmitting a second message to the first UE via the second UE, wherein the second message is configured to request negotiation, of an end-to-end shared key shared by the first UE and the third UE, with the first UE;
generating the end-to-end shared key by performing a security negotiation procedure with the first UE via the second UE; and
transmitting a third message to the first UE via the second UE, wherein the third message indicates completion of establishment of the end-to-end link.

8. The method according to claim 7, wherein the first message received by the third UE from the second UE is encrypted with a second key, and the second key is generated through negotiation between the third UE and the second UE during establishment of a PC5 link between the third UE and the second UE and is shared by the third UE and the second UE.

9. The method according to claim 7, wherein the method further comprises at least one of:
generating the end-to-end shared key by performing an Internet Key Exchange Vision2 (IKEv2) authentication procedure with the first UE via the second UE;
encrypting the third message with the end-to-end shared key; or
receiving user identity (ID) information transmitted by the second UE, wherein the user ID information comprises at least one of a source UE identity, a relay UE identity, or a target UE identity.

10. (canceled)

11. The method according to claim 8, wherein the third message is encrypted with the end-to-end shared key and the second key.

12. (canceled)

13. A method for establishing a direct link, performed by second user equipment (UE), comprising:
receiving a first message transmitted by first UE, wherein the first message is configured to request establishment of an end-to-end link, which is via the second UE, between the first UE and third UE, and the second UE is layer-2 relay UE;
transmitting the first message to the third UE;
receiving a second message transmitted by the third UE, wherein the second message is configured to request negotiation, of an end-to-end shared key shared by the first UE and the third UE, with the first UE;
transmitting the second message to the first UE, so as to facilitate generating the end-to-end shared key by performing a security negotiation procedure by the first UE and the third UE;
receiving a third message transmitted by the third UE, wherein the third message indicates completion of establishment of the end-to-end link; and
transmitting the third message to the first UE.

14. The method according to claim 13, wherein the first message received by the second UE from the first UE is encrypted with a first key, the first key is generated through negotiation between the first UE and the second UE during establishment of a PC5 link between the first UE and the second UE and is shared by the first UE and the second UE, and the method further comprises:
decrypting, based on the first key, the first message received from the first UE.

15. The method according to claim 13, wherein the first message transmitted by the second UE to the third UE is encrypted with a second key, the second key is generated through negotiation between the third UE and the second UE during establishment of a PC5 link between the third UE and the second UE and is shared by the third UE and the second UE, and the method further comprises:
encrypting, based on the second key, the first message obtained from the first UE.

16. The method according to claim 15, wherein the third message received by the second UE from the third UE is encrypted with the end-to-end shared key and the second key, and the method further comprises:
decrypting, based on the second key, the third message received from the third UE.

17. The method according to claim 14, wherein the method further comprises encrypting, based on the first key, the third message obtained from the third UE, in a case where the third message transmitted by the second UE to the first UE is encrypted with the end-to-end shared key and the first key; or the method further comprises:
transmitting a proximity service (ProSe) key request to a proximity key management function (PKMF) network element or a direct discovery name management function (DDNMF) network element of the second UE, wherein the ProSe key request comprises a credential ID and a relay service code (RSC)/ProSe code for requesting a long-term credential related to the credential ID and the RSC/ProSe code from the PKMF network element or the DDNMF network element, and the long-term credential is configured to generate the first key and a second key; and
receiving a ProSe key response from the PKMF network element or the DDNMF network element, wherein the ProSe key response carries the long-term credential.

18-21. (canceled)

22. A communication device, comprising:
a transceiver;
a memory; and
one or more processors collectively connected to the transceiver and the memory respectively, wherein the one or more processors are collectively configured to:
control the transceiver to transceive radio signals, and
cause the communication device to act as first user equipment (UE) and perform the method according to claim 1.

23. A system, comprising:
a source user equipment (UE),
a relay UE, and a target UE,
wherein the source UE is configured to perform the method according to claim 1.

24. A non-transitory computer-readable storage medium, storing computer-executable instructions, wherein the computer-executable instructions when collectively executed by one or more processors of the first user equipment (UE) cause the first UE to execute the method according to claim 1.

25. A communication device, comprising:
a transceiver;
a memory;
and one or more processors collectively connected to the transceiver and the memory respectively, wherein the one or more processors are collectively configured to:
control the transceiver to transceive radio signals, and
cause the communication device to act as third user equipment (UE) and perform the method according to claim 7.

26. A communication device, comprising:
a transceiver;
a memory; and
one or more processors collectively connected to the transceiver and the memory respectively, wherein the one or more processors are collectively configured to:
control the transceiver to transceive radio signals by executing computer-executable instructions on the memory, and
cause the communication device to act as second user equipment (UE) and perform the method according to claim 13.

27. A non-transitory computer-readable storage medium, storing computer-executable instructions, wherein the computer-executable instructions when executed by one or more processors of third user equipment (UE) cause the third UE to perform the method according to claim 7.

28. A non-transitory computer-readable storage medium, storing computer-executable instructions, wherein the computer-executable instructions when executed by one or more processors of second user equipment (UE) cause the second UE to perform the method according to claim 13.
